(19) United States
(12) Patent Application Publication
(10) Pub. No.: US 2025/0314868 A1
(43) Pub. Date: Oct. 9, 2025

(54) CURVED LIGHT-SHEET MICROSCOPIC IMAGING DEVICE AND METHOD

(71) Applicant: CHINESE INSTITUTE FOR BRAIN RESEARCH, BEIJING, Beijing (CN)

(72) Inventors: Jianglai WU, Beijing (CN); Lijuan TANG, Beijing (CN)

(21) Appl. No.: 19/172,264

(22) Filed: Apr. 7, 2025

(30) Foreign Application Priority Data
Apr. 8, 2024 (CN) 202410411108.3

(51) Int. Cl. G02B 21/00; G02B 21/36

(52) U.S. Cl. CPC G02B 21/0032; G02B 21/361

(57) ABSTRACT

A curved light-sheet microscopic imaging device comprises a microscopic imaging module, a curved light-sheet illumination module, and a sample scanning module. The curved light-sheet illumination module generates curvature-adjustable curved light-sheet illumination, Cooperating with a large field of view microscopy imaging device with field curvature can ensure that the entire imaging field is in a focused state; Combined with the sample scanning module, high flux microscopy imaging of centimeter sized transparent samples can be performed without the need for visual field stitching.

### RELATED APPLICATIONS

This application claims priority to Chinese Patent Application No. 202410411108.3 filed Apr. 8, 2024, the entire content of which is incorporated herein by reference.

### TECHNICAL FIELD

The present invention relates to the field of microscopic imaging technology, and more specifically, to a microscopic imaging device and method based on curved light-sheet illumination.

### BACKGROUND

Light-sheet microscopy offers advantages such as high spatiotemporal resolution, low phototoxicity, and reduced photobleaching, making it an essential tool for three-dimensional imaging of transparent biological samples. It is widely used in fields such as three-dimensional cell biology, developmental biology, and neuroscience. In recent years, with the continuous development of biological tissue transparency techniques, samples ranging from mouse brains to entire mice and even human brains can now be made optically transparent.

However, existing light-sheet microscopy techniques primarily rely on commercially available microscope objectives used in the field of life sciences for imaging, posing significant challenges in obtaining high-resolution three-dimensional structures of centimeter-sized transparent samples. Typically, these objectives are designed for observing small samples, resulting in a small space-bandwidth product (SBP, the number of optically resolvable spots within the field of view), which makes it difficult to achieve both large fields of view and high resolution simultaneously. Due to this limitation, existing light-sheet microscopes require field stitching when imaging centimeter-sized samples, reducing imaging flux and increasing the complexity of post-processing.

Improving the imaging flux of light-sheet microscopy depends on increasing the SBP of the microscope objective. In recent years, many custom-designed mesoscopic objectives have emerged, offering large fields of view and high-resolution imaging capabilities. However, due to the need to place centimeter-sized fields of view within the micrometer-scale imaging focal depth, these objectives struggle to maintain uniform imaging contrast and resolution across the entire field of view due to field curvature. Correcting field curvature requires adding more lenses, complicating the objective design, increasing manufacturing difficulty, and raising costs. Additionally, field curvature only bends the ideal image plane without blurring the image. These factors mean that field curvature is rarely fully corrected in objective designs, and even commercial flat-field objectives can only ensure that 80% of the field of view lies within the focal depth. Field curvature is also common in various custom-designed mesoscopic objectives. For point-scanning imaging techniques such as confocal microscopy and two-photon microscopy, field curvature has little impact on the final imaging quality if other aberrations (such as spherical aberration, coma, and astigmatism) are well corrected. However, for wide-field imaging techniques using cameras, such as light-sheet microscopy, field curvature can cause defocus in parts of the field of view, reducing imaging contrast and resolution. Therefore, there is a need for a technical solution to overcome these limitations in light-sheet microscopy when using objectives with field curvature.

In conventional imaging systems, imaging is typically performed on a flat plane. However, when a flat plane is imaged through a simple optical system, the center of the object is closer to the lens, while the edges are farther away, resulting in an image plane that is not flat but curved. When imaged by a flat acquisition device, such as a camera, the center of the field of view may be in focus while the edges are blurred, or vice versa. This is known as field curvature.

### SUMMARY

To correct geometric aberrations in the system, the objective design becomes more complex, and to achieve a certain resolution while ensuring aberration-free imaging across the field of view, part of the field of view is often sacrificed. This is why the SBP of current objectives cannot be significantly increased. Current light-sheet microscopes use flat light-sheets for illumination and flat detectors for imaging. This design is limited by the system's SBP, making it difficult to achieve high imaging flux.

Therefore, we propose a novel “curved illumination-flat imaging” approach, breaking away from the conventional “flat illumination-flat imaging” method. By generating a curved light-sheet for illumination and designing an objective with field curvature, when the curvature of the light-sheet matches the field curvature of the objective, a flat image can be obtained on the image plane, allowing direct imaging with a flat detector while keeping every part of the field of view in focus. Based on this idea, we designed an objective with fixed field curvature, capable of imaging a 10 mm field of view with 1 mm resolution, achieving a SBP of 420 million pixels, one order of magnitude higher than most existing objectives. Moreover, this objective consists of only three lenses, making it structurally simpler than other objectives, with each lens offering significantly higher information flux. This objective can achieve diffraction-limited imaging across a wide range of refractive indices (1.33-1.6), making it suitable for all current tissue transparency methods.

In light of the above issues, embodiments disclosed herein include a new light-sheet microscopic imaging device and method, using curved light-sheet illumination in conjunction with a microscope objective with field curvature to ensure the entire imaging field of view remains in focus. By combining sample scanning and line-array camera detection, high-flux microscopic imaging of centimeter-sized samples can be achieved without the need for field stitching.

In one aspect, the embodiments disclosed herein include a curved light-sheet microscopic imaging device, comprising a microscopic imaging module, a curved light-sheet generation module, and a sample scanning module. characterized in that the curved light-sheet illumination module generates a curved light-sheet that coincides with the curved focal plane of the fluorescence imaging module, ensuring the entire field of view remains in focus. Further, the narrow strip field of view defined by the curved light-sheet illumination and fluorescence imaging module is detected by a time-delay integration camera, enabling imaging through sample scanning.

In another aspect, a limited distance correction objective is disclosed, characterized in that the focal plane is a curved plane. The objective consists of five lenses, including one singlet lens and two doublet glued lenses, with the first lens being a singlet lens. Preferably, the objective has a field of view diameter greater than 1 cm, a numerical aperture of 0.25, and more preferably is capable of imaging transparent samples located in the imaging chamber that match the refractive index of the imaging buffer. By controlling the distance between the imaging objective and the imaging chamber and the thickness of the imaging buffer during imaging, aberrations can be corrected when imaging transparent samples with different refractive indices. Specifically, the imaging resolution can reach the diffraction limit for samples with refractive indices between 1.33 and 1.60.

In yet another aspect, a curved light-sheet illumination device is disclosed. The device includes an x-direction focusing cylindrical lens, conical lens, blade prism reflector, and y-direction focusing cylindrical lens. characterized in that the device generates an annular focus by focusing an annular beam. Specifically, the blade prism reflector splits the annular focus into two equal parts, forming symmetric bilateral curved light-sheet illumination. Preferably, the focusing directions of the x and y-direction focusing cylindrical lenses are perpendicular, and their focal planes coincide. More preferably, by adjusting the distance between the conical lens and the x and y-direction focusing cylindrical lenses respectively, the curvature of the curved light-sheet generated by the curved light-sheet illumination device can be adjusted to match the curved focal plane of the objective, the imaging requirements of different objective lenses with different curvatures of curved focal surfaces can be met.

In a specific embodiment, a curved light-sheet microscopic imaging device is disclosed, characterized by comprising a curved light-sheet illumination module, a sample scanning module, and a microscopic imaging module. Wherein the curved light-sheet illumination module generates curvature-adjustable curved light-sheet illumination, the sample scanning module scans the tissue sample to be tested, and the focal plane of the microscopic imaging module is curved to image the sample. The curved light-sheet generated by the curved light-sheet illumination module coincides with the curved focal plane of the microscopic imaging module, and imaging is performed by a time-delay integration camera through sample scanning.

Specifically, the curved light-sheet microscopic imaging device is characterized in that the microscopic imaging module includes an imaging objective, a filter, and a time-delay integration camera. Preferably, the curved light-sheet microscopic imaging device is characterized in that the curved light-sheet illumination module can be either bilateral or unilateral curved light-sheet illumination. The laser beam emitted by the curved light-sheet illumination module is parallel to the scanning direction of the sample. The curvature of the curved light-sheet generated by the curved light-sheet illumination module is adjustable. More specifically, the curved light-sheet illumination module consists of x-direction focusing cylindrical lens, conical lens, blade prism reflector, and y-direction focusing cylindrical lens, and is characterized by generating symmetric bilateral curved light-sheet illumination by splitting and focusing an annular beam.

A curved light-sheet microscopic imaging method is characterized by the curved light- sheet illumination module generating curvature-adjustable curved light-sheet illumination, the sample scanning module scanning the tissue sample to be tested, and the focal plane of the microscopic imaging module being curved to image the sample. The curved light-sheet generated by the curved light-sheet illumination module coincides with the curved focal plane of the microscopic imaging module and is detected by a time-delay integration camera. A method for fixing samples in curved light-sheet imaging, characterized in that harder samples are directly fixed on a holder and immersed in imaging medium for imaging. Softer samples are embedded and placed in a cuvette, with the cuvette sealed by cover slips, leaving the front of the sample imaging surface uncovered. The sample is stably fixed on the holder, and imaging is performed synchronously by a time-delay integration camera during uniform scanning.

An objective for illuminating curved light-sheets in microscopy imaging devices, wherein the focal plane of the objective is curved. The objective consists of five lenses elements, including one singlet lens and two doublet glued lenses, with the first lens being a singlet lens. The objective has a field of view diameter greater than 1 cm, a numerical aperture of 0.25. It images transparent samples by controlling the distance between the imaging objective and the sample and the thickness of the imaging buffer during imaging, to correct aberrations caused by imaging transparent samples with different refractive indices.

### BRIEF DESCRIPTION OF THE DRAWINGS

FIG. 1 shows a schematic optical configuration of a curved light-sheet microscopic imaging device according to an embodiment;

FIG. 2 shows a diagram of the microscopic imaging module in the curved light-sheet microscopic imaging device according to an embodiment.

FIG. 3 shows a diagram of the curved light-sheet illumination module in the curved light-sheet microscopic imaging device according to an embodiment.

FIG. 4 shows a locally magnified diagram of the focal plane in the curved light-sheet microscopic imaging device.

FIG. 5 shows the optical simulation design of the imaging objective in the curved light-sheet microscopic imaging device according to an embodiment.

FIG. 6 shows the variation of the root mean square (RMS) wavefront error with the field of view for the designed imaging objective when the refractive index of the imaging buffer is between 1.33 and 1.60, according to an embodiment.

FIG. 7 shows the field curvature test results of the objective lens fabricated based on the simulation design according to an embodiment.

FIG. 8 shows the resolution test results of the objective fabricated based on the simulation design according to an embodiment.

FIG. 9-1 shows the optical simulation design of the curved light-sheet illumination module in the curved light-sheet microscopic imaging device according to an embodiment (side view).

FIG. 9-2 shows the optical simulation design of the curved light-sheet illumination module in the curved light-sheet microscopic imaging device according to an embodiment (top view).

FIG. 10 shows an example of the curved light-sheet generated by the curved light-sheet illumination module according to an embodiment.

FIG. 11 shows the axial resolution of the curved light-sheet microscopic imaging device according to an embodiment.

FIG. 12 shows the contrast across the entire field of view of the curved light-sheet microscopic imaging device according to an embodiment.

FIG. 13 shows a flowchart of the curved light-sheet microscopic imaging method according to an embodiment.

FIG. 14 shows the sample holders for the curved light-sheet microscopic imaging method according to an embodiment.

FIG. 15 shows the three-dimensional imaging results of the mouse brain (labeled with green fluorescent protein) that was transparent using the oil transparency method using the curved light-sheet microscopy imaging device according to the disclosed embodiment.

FIG. 16 shows the three-dimensional imaging results of transparent mouse whole brain (stained with propidium iodide) using a curved light-sheet microscopy imaging device according to the disclosed embodiment.

### DETAILED DESCRIPTION OF THE EMBODIMENTS

To enable those skilled in the art to better understand the technical solutions, the embodiments are described in detail below with reference to the accompanying drawings. The embodiments described with reference to the drawings are exemplary and are intended to explain the embodiments, not to limit it.

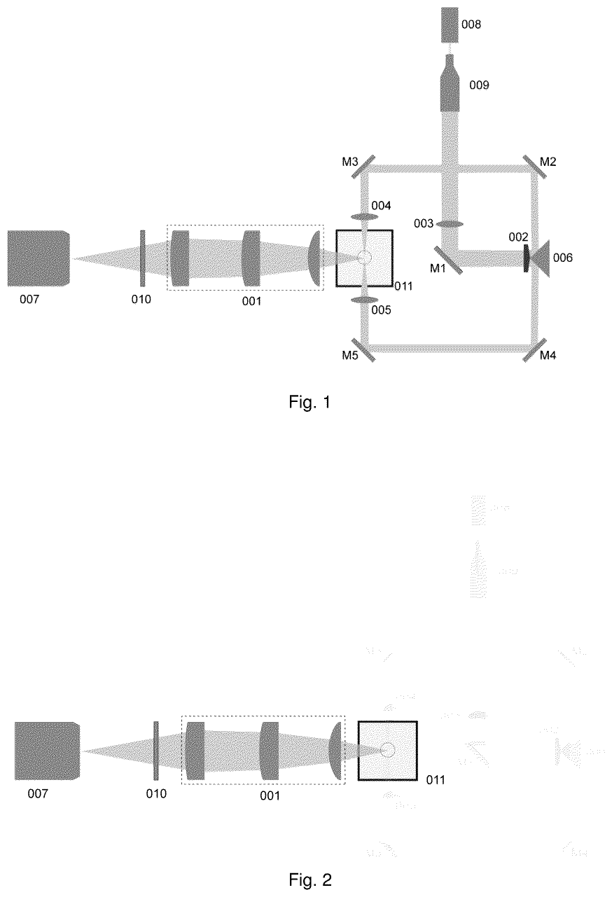

FIG. 1 shows a schematic diagram of the curved light-sheet microscopic imaging device according to an embodiment. The device includes three modules: a microscopic imaging module (FIG. 2), a curved light-sheet illumination module (FIG. 3), and a sample scanning module. A continuous-wave laser 008 (wavelength 488 nm or 561 nm) is collimated and expanded by a beam expander 009, then passes through y-direction focusing cylindrical lens 003, reflector M1, and conical lens 002. The beam is split into two paths by blade prism reflector 006. One path passes through reflector M2 and M3, x-direction focusing cylindrical lens 004, the other path passes through reflector M4 and M5,x-direction focusing cylindrical lens 005, to form symmetric bilateral curved light-sheet illumination in the imaging chamber 011. The excited fluorescence passes through objective 001 and filter 010, and is imaged by time delayed integrator camera 007. The microscopic imaging system of this embodiment can achieve 10 mm imaging field of view and 1 mm resolution, with a SBP over 4×108 for the entire system.

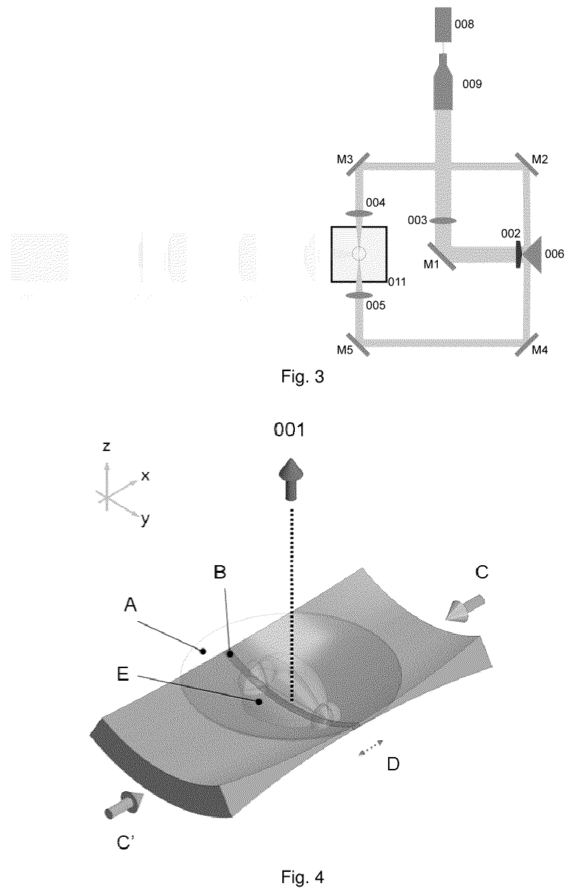

FIG. 4 shows a magnified local view near the focal plane of the curved light-sheet microscopic imaging device. Wherein A is the curved focal plane, B is the imaging field of view, C and C′ are curved light-sheet illumination, D denotes sample scanning, E is the sample, 001 is the imaging objective. The focal plane of the microscopic imaging module is curved surface A, the curved light-sheet (C and C′) generated by the curved light-sheet illumination module coincides with this curved focal plane of the microscopic imaging module for fluorescence excitation. The narrow strip field of view B is directly projected onto the time-delay integration camera 007 through the imaging objective 001 and filter 010 for sample scanning and imaging. For ease of presentation, the x, y, and z directions are defined as shown in FIG. 4, with x direction representing the propagation length of the light-sheet, y direction representing the width of the light-sheet, and z direction representing the imaging optical axis.

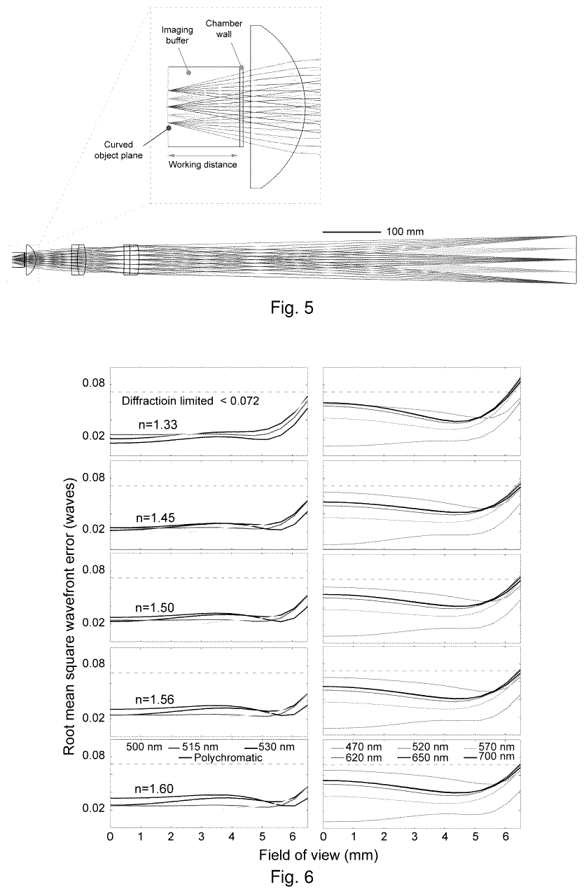

The microscopic imaging module, as shown in FIG. 2, consists of imaging objective 001, filter 010, and a time-delay integration camera 007. The imaging objective 001 images transparent samples immersed in the imaging chamber 011 without contacting the imaging buffer, effectively preventing contamination or damage to the objective and reducing maintenance costs, Beneficial for its promotion and application. FIG. 5 shows the optical simulation design of the imaging objective 001 in the curved light-sheet microscopic imaging device according to an embodiment of the present disclosure, with key parameters: 20 mm working distance, a numerical aperture of 0.25, 8× magnification, a 974 mm distance from the object plane to the image plane, a 13 mm imaging field of view, a 118 mm focal length, and a primary working wavelength range of 500-530 nm (full range: 470-700 nm). The objective 001 directly projects the magnified image from the focal plane to the image plane without the need for a large tube lens. The objective 001 is optimized to image through approximately 20 mm thickness of imaging buffer and a 1 mm thick fused silica glass simulating the sample chamber wall (enlarged view). This simplified design reduces the risk of contamination of objective by Transparent reagents. Table 1 provides detailed lens parameters. Since the imaging objective design does not need to consider field curvature, the difficulty of objective lens design and processing is significantly reduced. The imaging objective 001 consists of five lens (one singlet lens and two doublet glued lenses), has limited distance correction, and does not require a large-diameter cylindrical lenses, further reducing costs. By adjusting the curvature of the curved focal plane, the thickness of the imaging buffer, and the distance between the imaging objective 001 and the imaging chamber 011, When the refractive index of the imaging buffer is between 1.33 and 1.60 (meeting the imaging requirements of all transparency methods), and the working wavelength range is 470-700 nm, the imaging field of view of the imaging objective 001 exceeds 1 cm and the resolution can reach the diffraction limit (as shown in FIG. 6). The working distance of objective 001 (measured by the thickness of the imaging solution during imaging) is approximately 2 cm, allowing imaging of entire transparent mouse brains without the need for sample sectioning.

TABLE 1
Optical simulation parameters of the microscope
objective 001 in the curved light-sheet microscopic
imaging device according to the embodiments.

| | | | | Thick- | | Semi- |
|---|---|---|---|---|---|---|
| | | | Radius | ness | | diameter |
| Surface | | Type | (mm) | (mm) | Material | (mm) |
| 0 | Focal plane | Standard | 44.64 | 21.62 | WATER | 5.00 |
| 1 | Chamber | Standard | Inf | 1.00 | F_SILICA | 12.50 |
| 2 | wall | Standard | Inf | 2.21 | | 12.50 |
| 3 | Singlet | Standard | Inf | 16.30 | N-BK7 | 25.40 |
| 4 | | Standard | −30.90 | 61.71 | | 25.40 |
| 5 | Doublet | Standard | Inf | 10.00 | N-SF11 | 25.40 |
| 6 | lens | Standard | 91.10 | 15.00 | N-BK7 | 25.40 |
| 7 | | Standard | −87.80 | 65.75 | | 25.40 |
| 8 | Doublet | Standard | −542.10 | 10.00 | N-SF11 | 25.40 |
| 9 | lens | Standard | Inf | 16.00 | N-BAF10 | 25.40 |
| 10 (stop) | | Standard | −120.30 | 754.59 | | 25.40 |
| 11 | Image plane | Standard | Inf | | | 40.00 |

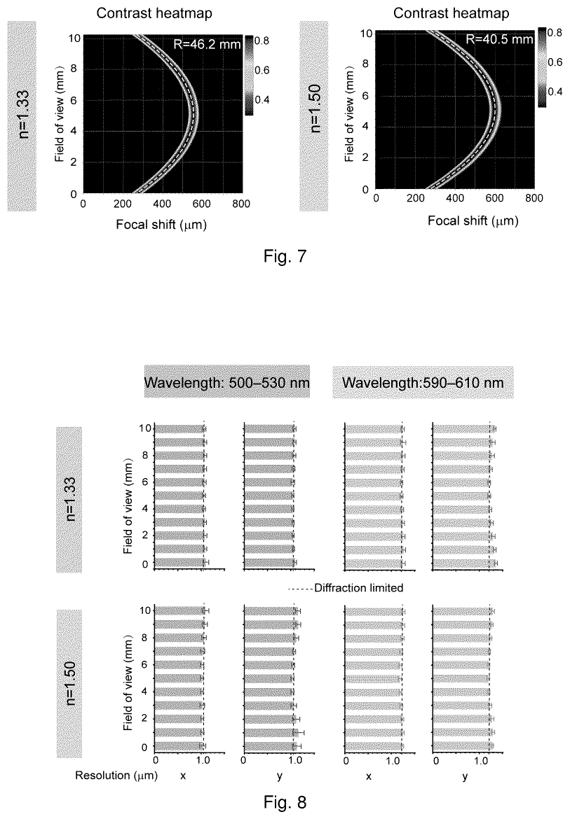

FIG. 7 shows the field curvature test results of the objective lens fabricated based on the simulation design according to an embodiment of the present disclosure, When the refractive index of the imaging buffer is 1.33 and 1.50, the corresponding curvature of the curved focal plane is 40.6 mm and 46.2 mm. Imaging of a 500 nm diameter fluorescent sphere using the curved light-sheet microscopic imaging device confirmed that the lateral resolution of the imaging objective 001 could reach the diffraction limit throughout the entire 1 cm field of view when the refractive indices of the imaging buffer were 1.33 and 1.50.When the wavelength is 500-530 nm, the resolution is 1 mm. When the wavelength is 590-610 nm, the resolution is 1.2 mm (FIG. 8).

It should be noted that the embodiment of the invention only provides one configuration of a high SBP imaging objective with a curved focal plane and does not limit the specific design of the objective. Those skilled in the art can select any objective with a curved focal plane according to actual application requirements, as long as it achieves the functions described in the embodiment. To ensure uniform sample illumination, the embodiment uses bilateral illumination to generate the curved light-sheet for microscopic imaging. However, the curved light-sheet microscopic imaging method is not limited to bilateral illumination; unilateral illumination can also generate curved light-sheet for microscopic imaging of samples.

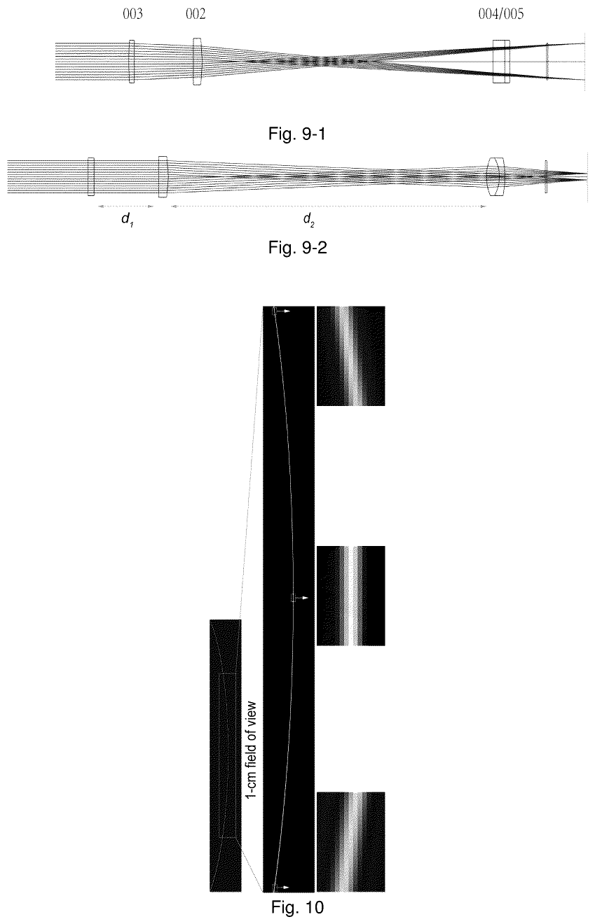

FIG. 3 shows the curved light-sheet illumination module. The laser output from continuous-wave laser 008 (488 nm or 561 nm) is collimated and expanded by beam expander 009, then focused by y-direction focusing cylindrical lens 003 and conical lens 002 to form a circular beam that converges in the y-direction. The resulted annular beam is split into two equal parts along x-direction by blade prism reflector 006, focused by x-direction focusing cylindrical lenses 004 or 005, to form symmetric bilateral curved light-sheet illumination in the detection region of imaging chamber 011. When the focal planes of the x and y-direction focusing cylindrical lenses coincide in the detection region, uniform light-sheet illumination is achieved. FIGS. 9-1 and 9-2 show the side and top views of the optical simulation design of the curved light-sheet illumination module in the curved light-sheet microscopic imaging device according to an embodiment, with detailed simulation parameters provided in Table 2. By adjusting the distance between conical lens 002 and y-direction focusing cylindrical lens 003, and adjusting the distance between conical lens 002 and x-direction focusing cylindrical lenses 004 and 005, the curvature of the curved light-sheet can be adjusted to align it with the focal plane of the microscopic imaging module's curved surface within the imaging field. This curvature adjustment mechanism can meet the requirement of the curvature of the curved focal plane of the microscopic imaging module changing with the refractive index of the imaging buffer. It should be noted that the annular beam in this embodiment is generated by conical lens 002, It is not a specific limitation on the method of generating circular beams. Other methods, such as using a spatial light modulator, can also be used to generate the annular beam, as long as they achieve the same function.

TABLE 2
Optical simulation parameters of the curved light-sheet illumination module in
the curved light-sheet microscopic imaging device according to the embodiments

| | | | | Thick- | | |
|---|---|---|---|---|---|---|
| | | | | ness | | Semi- |
| Surface | | Type | Radius | (mm) | Material | diameter |
| 0 | Focal plane | Standard | Infinity | Infinity | | 0.00 |
| 1 | Aperture | Standard | Infinity | 50.00 | | 10.00 |
| 2 | y-direction | Toroidal | 155.10 | 3.72 | N-BK7 | 11.70 |
| 3 | focusing | Toroidal | Infinity | 40.00(d₁) | | 11.70 |
| | cylindrical lens | | | | | |
| 4 | Conical lens | Standard | Infinity | 6.11 | F_SILICA | 12.70 |
| 5 | apex angle 170° | OddAsphere | Infinity | 197.00(d₂) | | 12.70 |
| 6 | x-direction | Toroidal | 30.56 | 8.00 | N-BK7 | 11.69 |
| 7 | focusing | Toroidal | −23.98 | 3.39 | N-SF10 | 11.69 |
| 8 | cylindrical lens | Toroidal | 58.51 | 25.00 | | 11.69 |
| 9 | Imaging chamber | Standard | Infinity | 1.00 | F_SILICA | 8.58 |
| | wall | | | | | |
| 10 | Imaging buffer | Standard | Infinity | 25.00 | WATER | 8.63 |
| 11 | image plane | Standard | Infinity | | | 10.02 |

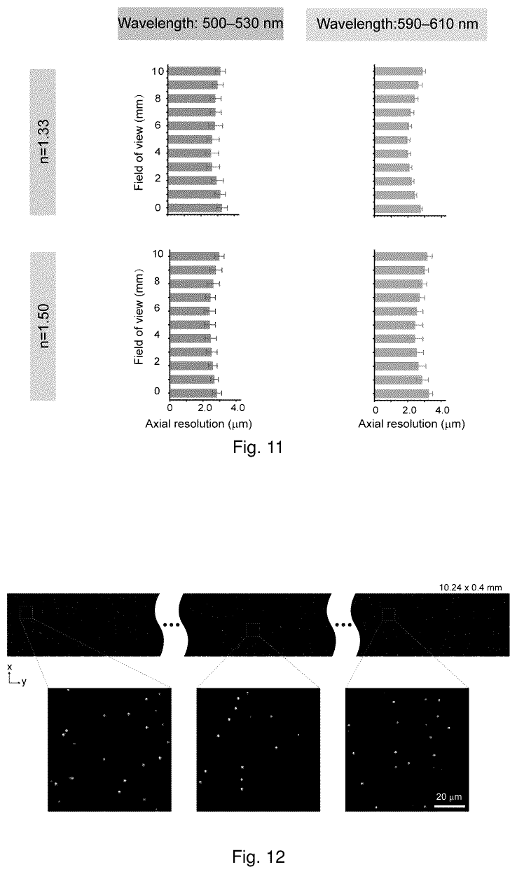

FIG. 10 shows an example of the curved light-sheet generated by the curved light-sheet illumination module according to the embodiments of the present disclosure confirming that the light-sheet generated by the curved light-sheet illumination module effectively covers a 1 cm field of view in the y-direction with uniform intensity distribution throughout the entire field of view. Using the curved light-sheet microscopic imaging device, a fluorescent ball with a diameter of 500 nm was imaged. When the refractive index of the imaging buffer was 1.33 and 1.50, 488 nm and 561 nm lasers were used for excitation, and the axial resolution of the entire field of view, i.e., the thickness of the light-sheet, was 2.5-3.0 mm (FIG. 11). The narrow strip field of view defined by the curved light-sheet (80 mm×1 cm) is projected onto the time-delay integration camera 007 through the imaging objective 001 and filter 010 for sample scanning and imaging. Further, By imaging a fluorescent sphere with a diameter of 500 nm, it can be confirmed that the light-sheet illumination generated by the curved light-sheet illumination module can ensure uniform imaging contrast throughout the entire field of view (FIG. 12).

It should be noted that the narrow strip field of view is primarily determined by the imaging range of the time-delay integration camera 007. In the x-direction, the confocal length of the light-sheet generated by the curved light-sheet illumination module matches the field of view defined by camera 007, ensuring optimal optical sectioning effect.

The sample scanning module uses a motorized translation stage to move the sample back and forth along the x-direction within the imaging chamber 011, synchronizing the sample scanning with the line scanning of the time-delay integration camera 007. This working mechanism enables the curved light-sheet microscopic imaging device to obtain uniform imaging contrast in the x-direction and improves imaging sensitivity by extending the exposure time for moving samples. The scanning distance of the sample within the imaging chamber 011 determines the x-direction field of view of the curved light-sheet microscopic imaging device. For example, using a 5×5×5 cm³ imaging chamber allows a scanning distance of approximately 2 cm. With a y-direction field of view of 1 cm, the curved light-sheet microscopic imaging device achieves a maximum field of view of 2×1 cm², enabling imaging of centimeter-sized samples, such as transparent mouse brains, without the need for image stitching. This significantly improves imaging flux and reduces the complexity of post-processing. The sample scanning speed determines the imaging speed; for example, a scanning speed of 1 cm/s allows imaging of a 1×1 cm² field of view in 1 second. The sample scanning module also uses another motorized translation stage for z-direction scanning, enabling three-dimensional imaging of the sample.

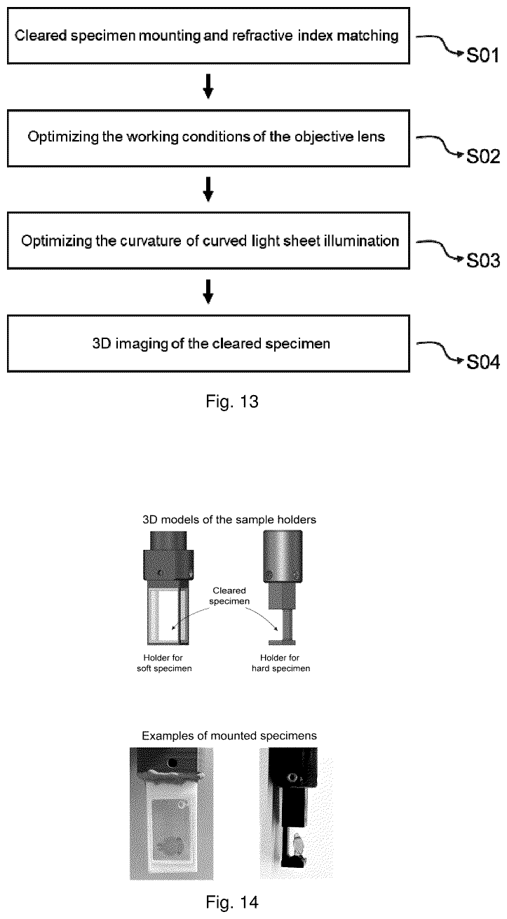

The above description, with reference to FIGS. 1-12, provides a detailed explanation of the curved light-sheet microscopic imaging device according to the embodiments. Below, with reference to FIGS. 13-16, the curved light-sheet microscopic imaging method according to the embodiments is described. FIG. 13 shows a flowchart of the curved light-sheet microscopic imaging method. As shown in FIG. 13, the method includes the following steps:

Step S01: Fixation of transparent samples and refractive index matching. The curved light-sheet microscopic imaging method according to the embodiments can be used for imaging transparent samples using all transparency methods. As shown in FIG. 14, hard samples (transparent samples obtained by oil transparency method) are fixed directly with UV glue, while soft samples (transparent samples obtained by water transparency method) are embedded in a fixed device, The fixed sample is placed in the imaging chamber 011 filled with imaging buffer. The refractive index of the imaging buffer must match that of the transparent sample to avoid aberrations caused by difference in refractive index between the two.

Step S02: Determination of optimal conditions for imaging objective 001 By imaging a fluorescent ball with a diameter of 500 nm and observing the imaging effect of the central field of view, the distance between the imaging objective 001 and the imaging chamber 011, as well as the thickness of the imaging solution during imaging, are repeatedly adjusted until the central field of view imaging is clear and the resolution reaches the diffraction limit.

Step S03: Determination of the curvature of curved light-sheet. Based on Step S02, the distance between the conical lens 002 and the x and y-direction focusing cylindrical lenses in the curved light-sheet illumination module is further adjusted to modify the curvature of the curved light-sheet until the entire field of view is clear and the resolution reaches the diffraction limit, indicating that the curved light-sheet entirely matches the curved focal plane.

Step S04: 3D imaging of samples. Depending on the size of the sample and the fluorescence intensity, the lateral scanning field of view and speed, the axial scanning range and speed, and the line scanning speed of the time-delay integration camera 007 are defined to obtain three-dimensional images of the sample.

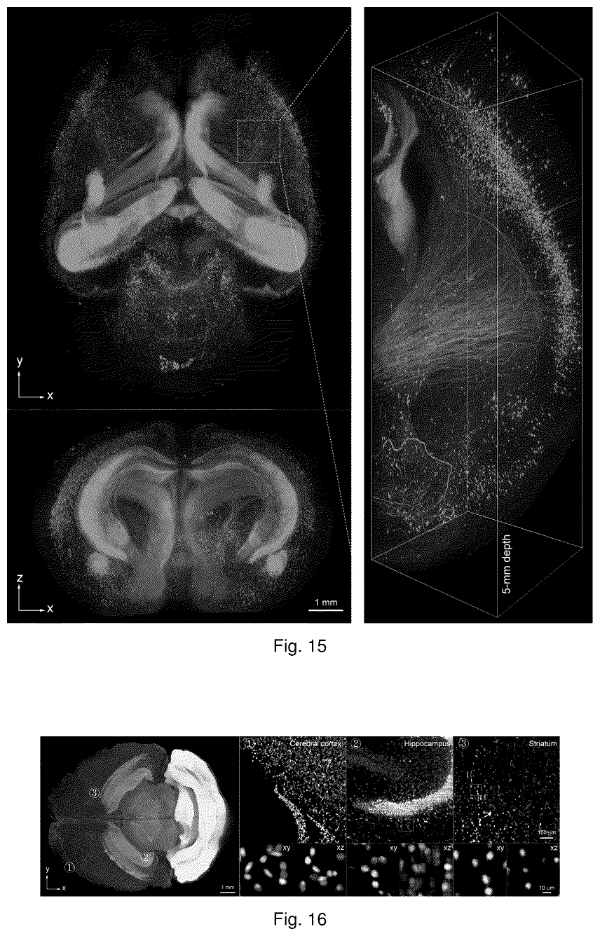

FIG. 15 shows the three-dimensional imaging results of the mouse brain (labeled with green fluorescent protein) that was transparent using the oil transparency method using the curved light-sheet microscopy imaging device according to the disclosed embodiment. During imaging, the sample was moved at a speed of 10 mm/s, corresponding to a camera line scanning rate of 16 kHz. The entire sample was imaged in approximately 3.5 hours, with a voxel size of 0.625×0.625×1.25 mm³ and a data volume of 1 TB. The curved light-sheet microscope can image the entire brain tissue without stitching, achieving micrometer-level resolution with uniform resolution and contrast across the entire field of view, allowing clear observation of individual neuronal structures. This stitch-free approach not only saves post-processing time but also avoids stitching artifacts and errors.

FIG. 16 shows the three-dimensional imaging results of transparent mouse whole brain (stained with propidium iodide) using a curved light-sheet microscopy imaging device according to the disclosed embodiment. After being treated with a transparent reagent, the brain tissue expanded by approximately 1.25 times and was rotated 90 degrees to align its longest dimension with the light-sheet illumination direction. If placed vertically, it would exceed the 1 cm imaging field of view. The curved light-sheet microscopic imaging device according to the disclosed embodiment can image the horizontal field of view (10.24×15.31 mm²) of the sample at once with a resolution of 1 mm without stitching, which is impossible for other microscopes with similar resolution. During imaging, the sample was moved at a speed of 5 mm/s, corresponding to a camera line scanning rate of 8 kHz. Three different brain regions were selected for enlarged display in the figure, each of which can accurately distinguish individual cells. The use of this curved light-sheet microscope for whole-brain cell imaging provides significant help in counting all cells in the mouse brain, mapping the distribution of neuronal and glial cell types, and enabling more precise brain region division, defining its components, and deepening our understanding of brain structure.

Finally, it should be noted that the above embodiments are only exemplary and do not limit the scope of the embodiments. Those skilled in the art can modify the technical solutions described in the embodiments or replace some technical features with equivalents. Such modifications or replacements do not depart from the spirit and scope of the technical solutions disclosed in the present invention.

1. A curved light-sheet microscopic imaging device, comprising:
a curved light-sheet illumination module,;
a sample scanning module; and
a microscopic imaging module;
wherein:
the curved light-sheet illumination module generates curvature-adjustable curved light-sheet illumination,
the sample scanning module scans a tissue sample to be tested, and
a focal plane of the microscopic imaging module is curved to image the sample;
the curved light-sheet generated by the curved light-sheet illumination module coincides with the curved focal plane of the microscopic imaging module, and imaging is performed by a time-delay-integration camera during sample scanning.

2. The curved light-sheet microscopic imaging device according to claim 1, the microscopic imaging module comprising an imaging objective, a filter, and a time-delay-integration camera.

3. The curved light-sheet microscopic imaging device according to claim 1, the curved light-sheet illumination module being double-sided curved surface illumination or single-sided curved surface illumination.

4. The curved light-sheet microscopic imaging device according to claim 3, characterized in that a propagation direction of a laser beam emitted by the curved light-sheet illumination module is parallel to a scanning direction of the sample to be tested.

5. The curved light-sheet microscopic imaging device according to claim 1, characterized in that a curvature of the curved light-sheet generated by the curved light-sheet illumination module is adjustable.

6. The curved light-sheet microscopic imaging device according to claim 5, characterized in that the curved light-sheet is generated using a conical lens and two cylindrical lenses, wherein the conical lens forms an annular beam, and splitting the beam at the center of the annular beam produces symmetrical bilateral curved light-sheet illumination.

7. The curved light-sheet microscopic imaging device according to claim 6, characterized in that the curved light-sheet illumination module comprises x-direction focusing cylindrical lens, conical lens, blade prism reflector, and y-direction focusing cylindrical lens; wherein splitting and focusing the annular beam generates symmetrical bilateral curved light-sheet illumination.

8. An objective used for the curved light-sheet illumination of the curved light-sheet microscopic imaging device according to claim 1, characterized in that the focal plane of the objective is curved.

9. The objective of claim 8, characterized in that the objective comprises five lens, including one singlet lens and two doublet lenses, with a first lens of the five lenses being a singlet lens.

10. The objective of 8, characterized in that the field of view diameter of the objective is greater than 1 cm and the numerical aperture is 0.25.

11. The objective of claim 8, characterized in that it images transparent samples, and aberrations caused by transparent samples with different refractive indices are corrected by controlling a distance between the imaging objective and the sample, and a thickness of the imaging buffer medium during imaging.
